(19) United States
(12) Patent Application Publication
(10) Pub. No.: US 2006/0105085 A1
(43) Pub. Date: May 18, 2006

(54) Product pack

(76) Inventor: Susan Nicola Pieterse, St. Albans, Herts (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/525,584

(22) PCT Filed: Aug. 20, 2003
(86) PCT No.: PCT/GB03/03641

§ 371 Date: Nov. 21, 2005

(30) Foreign Application Priority Data
Aug. 22, 2002 (GB) 02919577.4

(51) Int. Cl. B65D 81/34; A21D 10/02; A23B 7/148

(52) U.S. Cl. 426/113; 426/112; 426/106

(57) ABSTRACT

A product pack (1) which when in use is adapted to house a combination of liquid and solid elements and which is designed to facilitate the separation of said elements by part of the pack being so constructed as to segregate and absorb a substantial portion of the liquid without any undue external leakage so that said part and its liquid can subsequently be discarded as waste.

### FIELD OF THE INVENTION

The present invention relates to product packs which when in use are adapted to house a combination of liquid and solid elements, and particularly those which are destined for use in ovens.

### BACKGROUND OF THE INVENTION

While the pack of the present invention, is envisaged to have a wide variety of fields of application, the starting point for this invention may be conventional packs for food products suitable for cooking in a conventional oven, microwave oven or combination oven. In this context, the conventional cooking process is a multi-stage process. The first stage of the process often involves the raw food product being placed in an oven on a metallic or cardboard carrier tray. Trays adapted for use in ovens are widely available in today's market place, and one such pack has been defined and described in U.S. Pat. No. 5,411,204 and may be used as a reference for prior art. After the first stage of placing the raw food in the oven on its corresponding tray and once the cooking process is complete, the food is usually removed from the oven and placed in sale or distribution packaging. In this type of cooking process, different containers are often used during the cooking phase and for sale or distribution purposes. Consequently, it is often required to double handle the products. Apart from this disadvantage of conventional systems, the cooking process frequently generates an undesirable amount of liquid such as grease or fat which is unsightly to the end users.

As this conventional cooking process is often present at food services where food is provided alongside non-food goods, this multi-stage cooking process is also undesirable due to the stringent demands on hygiene that often accompany these types of services.

One of the objectives of the present invention is to provide a pack for containing raw products initially, which can then be used at the point of sale or distribution and subsequently used to cook the products.

A further objective of the present invention is to provide a pack which can facilitate a one stage cooking process.

A further objective of the present invention is to provide a pack which can be used in microwaves, conventional ovens and combined ovens.

The present invention also aims to provide means that enable the unsightly and undesirable cooking process liquids to be absorbed away from the food and by so doing achieving a dry product.

### SUMMARY OF THE INVENTION

In a first broad aspect, the invention presents a product pack which when in use is adapted to house a combination of liquid and solid elements and which is designed to facilitate the separation of said elements by part of the pack being so constructed as to segregate and absorb a substantial portion of the liquid without any undue external leakage so that said part and its liquid can subsequently be discarded as waste.

This configuration has the advantage of enabling not just the absorption of unwanted liquid but also its separation into a segregated (i.e. compartmented part of the pack). This particular construction provides a particularly hygienic pack whilst presenting its contents in an aesthetical and desirable form.

In a subsidiary aspect, the pack comprises one or more porous membranes inside the pack through which, in use, the liquid passes to be subsequently absorbed.

The second configuration of features is particularly advantageous as it improves the degree to which the liquids are separated from the remaining contents of the pack. Therefore, this configuration even further improves the achievable hygiene of the pack and the presentation of its contents, as it also can visually separate the liquid and its absorbing means from the viewed product.

In a further subsidiary aspect, the pack material is ovenable. Suitable materials, as such, are known; but the advantages given by the invention are only appreciated fully when this non-obvious combination is made.

The advantages discussed with reference to the above aspects are particularly applicable when the pack material is ovenable as it does away with the common requirement of a multi-stage cooking process. Since the liquids absorbed are generally at elevated temperatures, the present inventive pack considerably reduces the risk of the pack's operator inadvertently burning himself whether during the cooking process or during consumption of the goods contained in the pack.

In a second broad independent aspect, there is provided a component, suitable for use as part of a pack in accordance with claim 1 and comprising an absorbent pad and a membrane, which in use, is intended to be in proximity to a combination of liquid and solid elements, the membrane incorporating pores to allow liquid to flow through the membrane and be absorbed by the pad, the pores of the membrane being sized so as to substantially prevent the passage of solid elements, whereby the component acts to segregate the liquid elements absorbed from solid elements.

This component is particularly advantageous because it allows the absorption of liquid in a compartmented manner so as to substantially prevent it from exiting the component. This allows the liquid to be discarded with improved separation from solid components.

### BRIEF DESCRIPTION OF THE DRAWINGS

FIG. 1 shows a cross-sectional view of a pack according to the first embodiment of the present invention.

FIG. 2 shows a plan view of the pack according to the first embodiment of the present invention.

FIG. 3 shows a cross-sectional view of a pack in accordance with a second embodiment of the present invention.

FIG. 4 presents a cross-sectional view of a third embodiment.

FIG. 5 shows a cross-sectional view of a pack in accordance with a fourth embodiment.

FIG. 6A shows a perspective view of the membrane in accordance with a further embodiment.

FIG. 6B shows the cross-section of one perforation of the membrane in accordance with a further embodiment

FIG. 6C shows a cross-section about a perforation according to a further embodiment of the invention.

FIG. 6D shows a perspective view of a portion of the membrane with one perforation according to a further embodiment of the invention.

FIG. 6E shows a schematic cross-sectional view of a membrane according to a further embodiment of the invention.

FIG. 7A shows a plan view of a component according to a further embodiment of the invention.

FIG. 7B shows a cross sectional view of a component of the embodiment of FIG. 7A.

FIG. 8 shows a perspective view of a component according to a further embodiment of the invention.

### DETAILED DESCRIPTION OF THE DRAWINGS

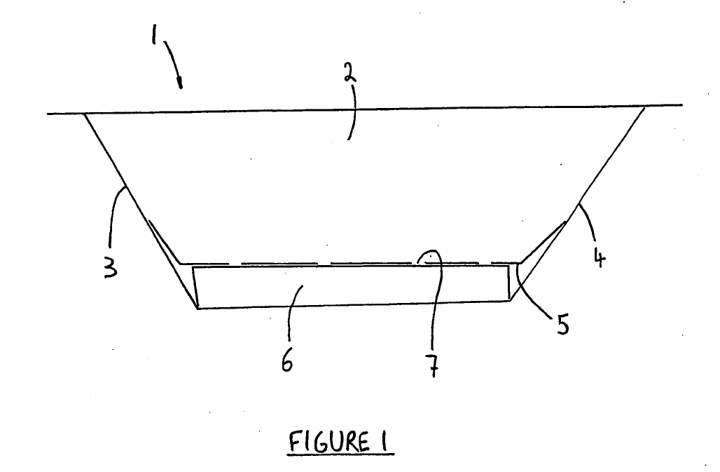

FIG. 1 shows a pack referenced 1 which when viewed in cross-section has a general trapezoidal form. Pack 1 incorporates two end walls such as that referenced and viewed in the drawing at 2 and two side walls 3 and 4. These walls form a container which may be sufficient in dimensions to receive raw food and be inserted in cooking appliances for processing.

A membrane 5 incorporating a number of perforations 7 divides the pack into two chambers one destined to receive the food or any other article for packaging and the other incorporating a cellulose fibre pad 6. The person skilled in the art will utilise a given geometry of the pad for any particular packaging application. In order to do so, he will take into account the viscosities of the liquids whose absorption into the pad is required.

In its primary application, the pack is envisaged for use at oven temperatures as well as in microwave conditions. An appropriate ovenable cardboard tray and a cellulose fibre pad will be selected amongst known alternatives. The cardboard itself will advantageously incorporate an impermeable coating to prevent any liquid escaping through the pack's wall. The invention also envisages that the material used for the membrane will be identical to that used for the pack's walls.

While cardboard and cellulose fibres are preferred materials, the invention is not limited to these and extends to other suitable materials such as metals or plastics.

Although not illustrated in this drawing, the pack will include a lid which may be retained to the containing walls of the pack by known means such as a heat seal or by folding.

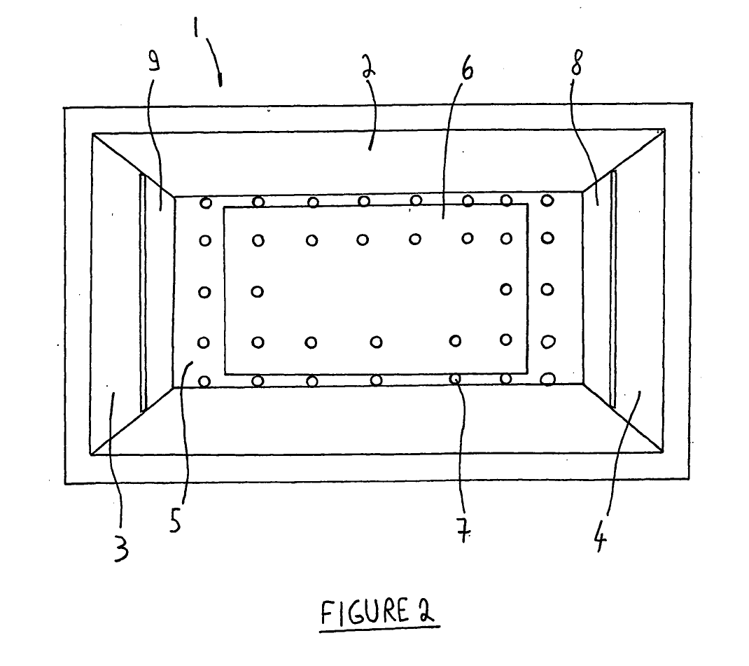

FIG. 2 displays the plan view of the pack shown in cross-section in FIG. 1. Identical reference numerals have been used for clarity. One of the aspects that becomes apparent in FIG. 2 is how the perforations 7 are placed about the membrane 5. A central portion of the membrane incorporates no perforations at all whilst the majority of the perforations follow a rectangular pattern generally in the vicinity of the walls. These perforations are circular in plan view and have a generally constant diameter along their depth. The membrane is affixed to the walls of the pack by ears 8 and 9 which may simply rest against the walls or be sealed thereto.

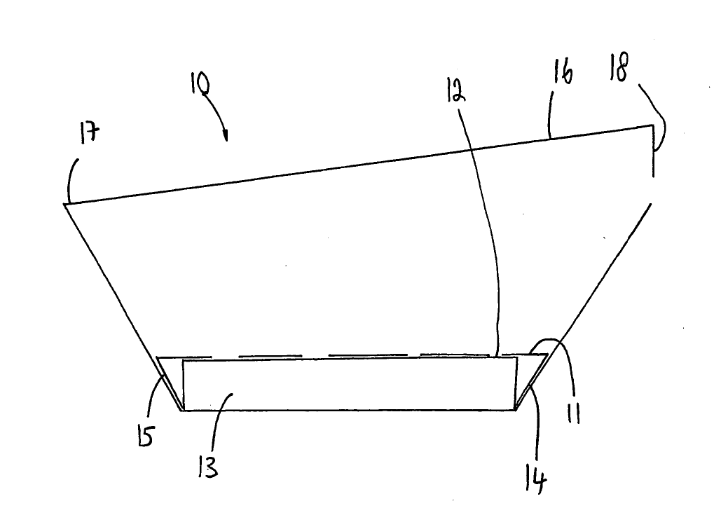

FIG. 3 shows a further pack generally referenced 10 which is trapezoidal in cross-section and comprises a membrane 11 with circular perforations 12 and an absorbent pad 13. In this configuration the ears 14 and 15 of membrane 11 are folded back and in effect become a double wall between the liquid absorbed in the pad 13 and its neighbouring environment. Pack 10 is provided with a lid 16 which hinges about extremity 17. The free extremity 18 of lid 16 may be sealed to the outer surface of the pack or in mating engagement in any other form known in the art.

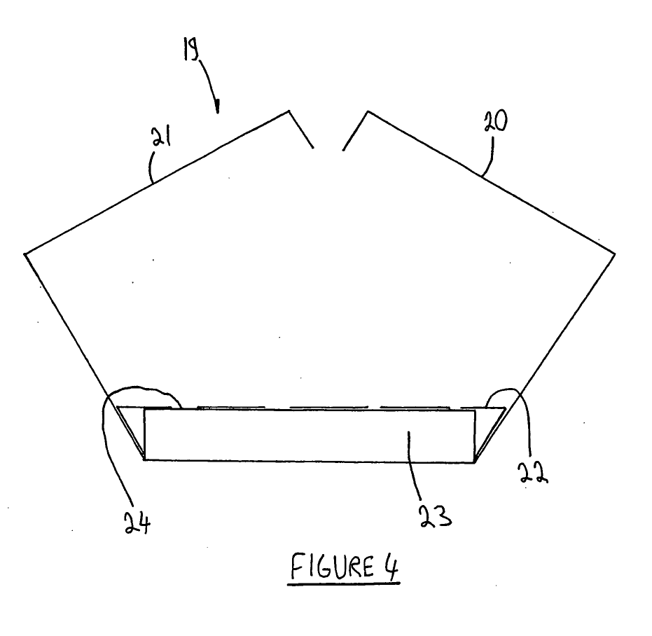

FIG. 4 shows a pack 19 with a split hinged lid whose halves are numbered 20 and 21 and may be joined at their free extremities by any known means. The pack 19 incorporates a membrane 22 and a cellulose fibre absorbing pad 23, the membrane 22 being perforated at a variety of locations such as perforation 24.

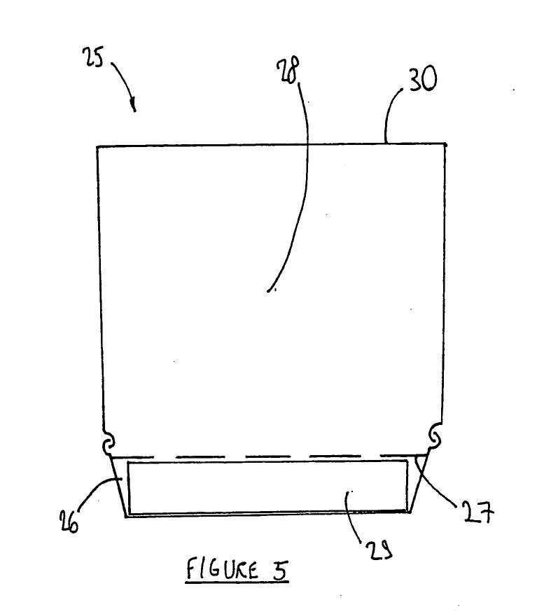

The previous embodiments have all illustrated packs with absorbing means in their base portion. FIG. 5 however shows a pack 25 destined to stand on its lid 26 during the cooking process so that its membrane 27 allows the passage of unwanted liquids from the food chamber 28 to the absorbent pad 29. It is envisaged that the properties of the absorbent pad 29 will be selected by the person skilled in the art to sufficiently retain any liquid entering into contact with the pad while the pack stands on its lid and then retains the liquid within the lid when the pack stands on its conventional base 30 (for example during delivery of the pack).

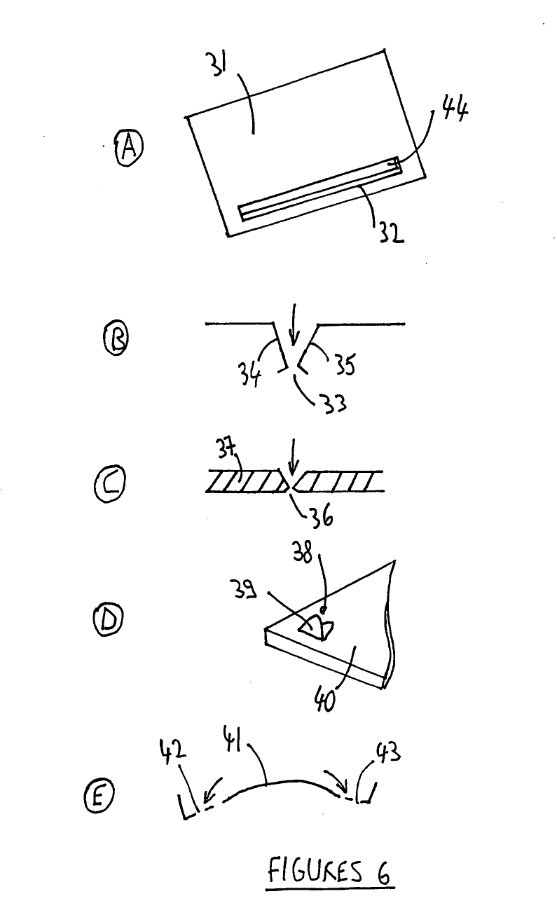

FIG. 6A illustrates a membrane 31 destined to separate consumable products of the pack from an absorbent pad (not illustrated in the drawing). Membrane 31 has the particularity of incorporating a single rectangular and elongate perforation 32 and a projection 44 resulting from the perforation process which extends inwards so as to create an additional barrier for any undesirable passage of fluid back to the containing chamber. Membrane 31 may be mounted into a pack so as to form a slope along which the liquid may run for enhanced passage through perforation 32 or a similar perforation, located about the edge of the membrane or at the lowest point of the membrane's slope.

FIG. 6B shows the perforation 33 destined to ameliorate the passage of liquid in the direction of the arrow illustrated. Portions 34 and 35 were part of the wall of the membrane prior to the perforation process. The perforation process used in this embodiment has the particularity of being a two step perforation process, the first step being the perforation of perforation 33 into two portions 34 and 35 and the second step consisting of folding the free extremities of these portions, preferably at three quarters of their depth so as to form a venturi which enhances the circulation of fluid in the arrow's direction while making a flow in the opposite direction extremely difficult.

FIG. 6C illustrates a perforation 36 through the membrane 37 which is in the shape of a double cone or conic with its neck being at three quarters of the depth of the membrane in order to improve the flow of liquid in the arrow's direction while as was the case in FIG. 6B rendering a counter flow almost impossible. In effect, this double cone shape promotes (as with FIG. 6B) a venture-like flow of liquid into the absorbent pad, whilst imposing the reverse fluid dynamics effect on any attempted back-flow. If the pack is disorientated—for example in “take-home” situations from a fast flow outlet—this is especially advantageous.

FIG. 6D illustrates a perforation 38 with a projection 39 extending from the membrane 40 towards the containing chamber (not illustrated in this drawing). Projection 39 is envisaged to be designed sufficiently rigid, when in use, to separate the contents of the pack from the rest of the membrane 40. This projection will also facilitate the localisation of the contents of the pack. By separating to a certain degree the contents of the pack and being able to localise them precisely, the separation of undesirable fluids is enhanced and any undesirable adhesion of the contents of the pack to the membrane is thought to be limited.

FIG. 6E shows the cross-section of the membrane 41 which defines an arc with perforations 42 and 43 at its extremities. The slope of the arc will of course accelerate the circulation of unwanted liquids to absorbing means which may in this case only be located below perforations 42 and 43. This latest option will reduce the required amount of pad necessary for absorbing the undesirable liquid contents of the pack

Whilst the advantages of this kind of pack become particularly apparent in the context of packs used in ovens that combine microwave and conventional heat, these pads are thought to be able to have other applications such as absorbing water residue resulting from de-freezing and even absorbing machining by-products around mechanical components.

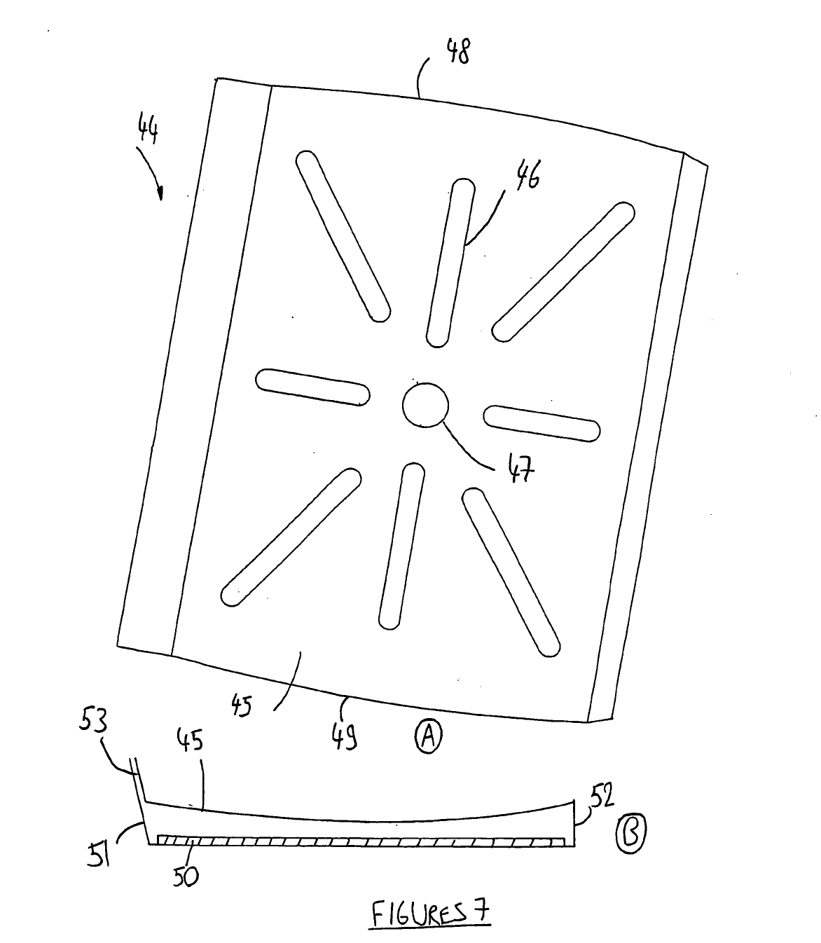

FIG. 7A shows a component generally referenced 44 which is suitable for use as part of a pack This component may also be used to carry on its own a mixture of solids and fluids. Component 44 is preferably made out of ovenable cardboard. The upper section of the component or membrane referenced 45 comprises an array of pores 46 of elongate shape. These elongate pores stretch radially separated one from another by 45°. All of these elongate pores 46 tend to converge towards a central circular pore 47. The geometry of each individual pore of membrane 45 and their arrangement relative to one another is particularly advantageous because drainage occurs at a greater rate than a more conventional array of circular pores. The elongate pores 46 allow liquids to flow because they exert a higher surface tension on any liquid passing through the pores. It therefore follows that there is little or no liquid build-up in the pores and flow through the pores is therefore virtually unrestrained.

Sides 48 and 49 are preferably curved so that when the component 44 is placed into a pack of conventional rectangular shape, the outer regions of the sides abut against the walls of the standard container causing the membrane to slope down towards its centre as can be seen in FIG. 7B. In use when the component is carrying food it will tend to slope further towards the centre which in this geometry of pores accelerates the absorption into the absorbent pad located beneath the membrane. A pad 50 has been illustrated in FIG. 7B where the membrane is spaced from the pad sufficiently to prevent any liquid from easily exiting the membrane 45. This spacing is achieved in this configuration by providing side walls 51 and 52. The membrane 45 and wall 51 may be joined together by appropriate adhesive means. From wall 51 a portion 53 of the component projects which allows the component to be easily handled for placing into an appropriate pack.

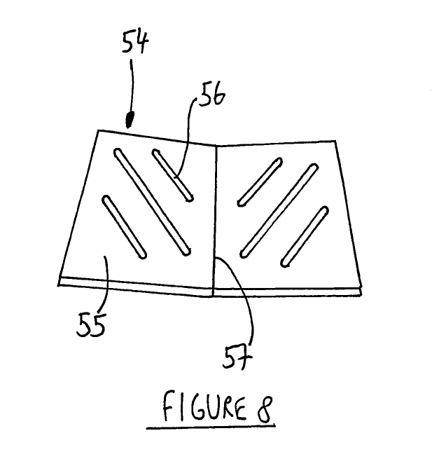

FIG. 8 shows a further component generally referenced 54 with a membrane 55 incorporating a number of diagonally orientated elongate pores 56. For additional rigidity there is provided a supporting member 57 extending across the component 54. This would for example prevent undue sagging of the component at its centre.

The present application also teaches that the component and the pack's inner wall of the kind described above may comprise an outer coating or laminate layer which is of a material such as an appropriate polyester which, at temperatures above 200°, softens and creates a bond at points where the component would engage an appropriate pack so that the component of this kind may be sufficiently fixed to the pack to be retained by the pack rather than being able to separate from the pack. This particular feature is also thought to be particularly advantageous as it will require no additional manufacturing steps such as attaching a component to a pack by conventional adhesives prior to locating the solid and liquid elements in the pack.

1-5. (canceled)

6. A product pack suitable for housing a combination of liquid and solid elements, comprising: a part of the pack for facilitating the separation of said elements; wherein the part of the pack is constructed to segregate and absorb a substantial portion of the liquid without any undue external leakage; whereby at least said part and its liquid can subsequently be discarded as waste.

7. A pack according to claim 6, comprising at least one porous membrane inside the pack through which, in use, the liquid passes and an absorbent pad; whereby the liquid having passed the membrane is subsequently absorbed by the pad.

8. A pack according to claim 7, comprising a space between said membrane and said pad; whereby the liquid passes the membrane and is subsequently absorbed by the pad whilst the space contributes to the segregation of the absorbed liquid from the solid elements in the pack.

9. A pack according to claim 6, wherein the pack material is ovenable.

10. A component, suitable for use as part of a pack in accordance with claim 6 and comprising an absorbent pad and a membrane, which in use, is intended to be in proximity to a combination of liquid and solid elements, the membrane incorporating pores to allow liquid to flow through the membrane and be absorbed by the pad, the pores of the membrane being sized so as to substantially prevent the passage of solid elements, whereby the component acts to segregate the liquid elements absorbed from the solid elements.
